(19) United States
(12) Patent Application Publication
(10) Pub. No.: US 2008/0235493 A1
(43) Pub. Date: Sep. 25, 2008

(54) INSTRUCTION COMMUNICATION TECHNIQUES FOR MULTI-PROCESSOR SYSTEM

(75) Inventor: Thomas Fortier, Montreal (CA)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/945,790

(22) Filed: Nov. 27, 2007

Related U.S. Application Data
(60) Provisional application No. 60/896,497, filed on Mar. 23, 2007.

(51) Int. Cl. G06F 15/16

(52) U.S. Cl. 712/31; 712/E09.065

(57) ABSTRACT

A method for communicating instructions to slave processors in a multi-processor system having a master processor and pipelined slave processors controlled by the master processor is described. The method uses a pass-through command having (i) a header block coded using a computer language understood by the slave processors and (ii) a payload block including instructions coded in a computer language understood by a destined slave processor. The pass-through command is transmitted to an outermost slave processor and then forwarded, without recoding, by intermediate downstream slave processors until the command reaches the destined slave processor. In one application, the method is used in a system adapted for processing video data or rendering graphics.

This application claims the benefit of U.S. Provisional Application No. 60/896,497, filed Mar. 23, 2007, the entire content of which are hereby incorporated by reference.

### TECHNICAL FIELD

The present disclosure relates generally to the field of multi-processor systems and, more specifically, to techniques for communicating instructions to a slave processor in a multi-processor system having a master processor and pipelined slave processors.

### BACKGROUND

In complex computer systems common workload is often distributed among and performed in parallel by a plurality of processors. A multi-processor system typically includes a master processor administering a plurality of pipelined (i.e., connected in series) processors or co-processors, which are collectively referred to herein as slave processors. For example, such multi-processor systems may be used for processing of large amounts of video data or rendering graphics, among others in computationally intensive applications.

In the multi-processor system, however, the master processor and each of the slave processors may operate using instructions (i.e., commands) and data formatted in their native and, as such, different programming languages. Conventionally, instructions forwarded by the master processor downstream to a respective slave processor are decoded by each intermediate slave processor in its native programming language, re-coded in the programming language of the next downstream intermediate slave processor, and then forwarded to that processor.

Such cycles of decoding the received instructions and, after re-coding in the native programming language of the downstream intermediate slave processor, forwarding them downstream continues until the instructions reach an intended, or destined, slave processor. At the destined slave processor, the received instructions are de-coded in the native programming language of that processor and executed.

Complexity of such multi-step routine for communicating instructions to slave processors adversely affects overall performance of the multi-processor system and, in particular, limits design flexibility and command throughput of the system. Despite the considerable efforts in the art devoted to increasing efficiency of communicating instructions from the master processor to the pipelined slave processors, further improvements would be desirable.

There is therefore a need in the art for techniques to efficiently implement communication of instructions to pipelined slave processors in multi-processor systems.

### SUMMARY

Techniques for communicating instructions to slave processors in a multi-processor system having a master processor and pipelined slave processors are described herein. In an embodiment, the master processor generates a pass-through command having a header block and a payload block that includes instructions to a destined slave processor. The header block is coded using a computer language understood by the pipelined slave processors, and the payload block is coded in a computer language understood by the destined slave processor. The master processor forwards the pass-through command to an outermost one of the pipelined slave processors and then the pass-through command is re-transmitted, without recoding, by intermediate (i.e., non-destined) slave processors until the pass-through command reaches the destined slave processor, which executes the instructions.

In one design, the system uses the inventive method to perform at least one of processing video data or rendering graphics.

Various aspects and embodiments of the invention are described in further detail below.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 shows a block diagram of an exemplary multi-processor system.

FIG. 2 shows a schematic diagram illustrating a structure of a pass-through command used in the multi-processor system of FIG. 1.

FIG. 3 shows a flow diagram illustrating a method for communicating instructions to pipelined slave processors in the multi-processor system of FIG. 1.

To facilitate understanding, identical reference numerals have been used, where possible, to designate identical elements that are common to the figures, except that suffixes may be added, when appropriate, to differentiate such elements. The images in the drawings are simplified for illustrative purposes and are not depicted to scale. It is contemplated that features or steps of one embodiment may be beneficially incorporated in other embodiments without further recitation.

The appended drawings illustrate exemplary embodiments of the invention and, as such, should not be considered as limiting the scope of the invention that may admit to other equally effective embodiments.

### DETAILED DESCRIPTION

The term “exemplary” is used herein to mean “serving as an example, instance, or illustration.” Any embodiment or design described herein as “exemplary” is not necessarily to be construed as preferred or advantageous over other embodiments or designs.

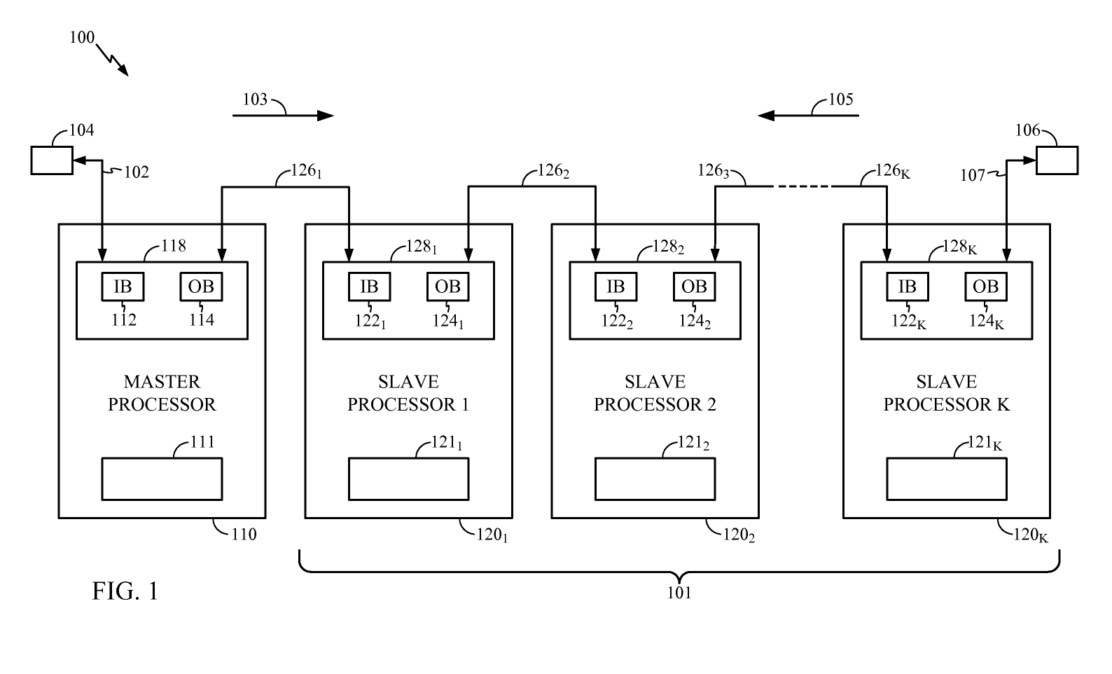

Referring to the figures, FIG. 1 depicts a block diagram of an exemplary multi-processor system 100 in accordance with one embodiment of the present invention. In exemplary applications, the system 100 may be used for processing video data and/or rendering graphics, among other computationally intensive data processing applications.

In one exemplary embodiment, the system 100 is a portion of a graphics processing unit (GPU) of a wireless communication apparatus, such as a cellular phone, a video game console, a personal digital assistant (PDA), a laptop computer, an audio/video-enabled device, and the like.

The GPU may be compliant, for example, with a document “OpenVG Specification, Version 1.0,” Jul. 28, 2005, which is publicly available. This document is a standard for 2-D vector graphics suitable for handheld and mobile devices, such as cellular phones and other referred to above wireless communication apparatuses.

In the depicted embodiment, the system 100 illustratively includes a master processor 110 and a plurality 101 of pipelined slave processors 120₁-120_{K}, which are connected using respective system interfaces 126₁-126_{K}, where K is an integer and K>2. In one embodiment, each of the system interfaces 126₁-126_{K} includes a data bus, an address buss, and a command bus (none is shown). The master processor 110 and each of the slave processors 120₁-120_{K} may contain sub-processors, memories, peripheral devices, and support circuits, and the like elements, which, for brevity, are collectively shown herein as modules 111 and 121₁-121_{K}, respectively.

The master processor 110 and pipelined slave processors 120₁-120_{K} may be formed on a single integrated circuit (IC) such as, for example, a system-on-chip (SoC) device. Alternatively, the master processor 110 and at least one of the slave processors 120₁-120_{K} may be formed on separate ICs.

In operation, the master processor 110 controls and, optionally, monitors data processing at the slave processors 120₁-120_{K}. The master processor 110 and each of the slave processors 120₁-120_{K} may operate using different formats (i.e., computer languages) for generating or executing internal instructions or internal data exchanges.

The master processor 110 comprises an input/output (I/O) module 118 including an input buffer (IB) 112 and an output buffer (OB) 114. Correspondingly, each of the slave processors 120₁-120_{K} comprises a respective input/output (I/O) module 128 including an input buffer 122 and an output buffer 124. In operation, the I/O modules 118 and 128₁-128_{K} facilitate information exchanges within the system 100 or to/from the system 100.

Using interface 102, the input buffer 112 of the master processor 110 may be connected to at least one of a remote processor, a network, or a user controls means, which are collectively shown as a means 104. Similarly, using interface 107, the output buffer 124_{K} of the slave processor 120_{K} may be connected to other remote processor, network, or user controls means, which are collectively shown as a means 106.

In the system 100, via a respective bi-directional system interface 126, an input buffer 122 of a preceding (i.e., upstream) slave processor 120 is connected to an output buffer 124 of the adjacent downstream slave processor, thus forming the plurality 101 of pipelined slave processors 120₁-120_{K}. For example, an input buffer 122₂ of a slave processor 120₂ is connected, via a system interface 126₂, to an output buffer 124₁ of a slave processor 120₁, and an output buffer 124₂ of the slave processor 120₂ is connected, via a system interface 1263, to an input buffer 1223 of a slave processor 120₃ (not shown).

In one embodiment, the output buffer 114 of the master processor 110 is connected, via a system interface 126₁, to an input buffer of an outermost slave processor of the plurality 101 of the pipelined slave processors 120, i.e., to an input buffer 122₁ of the slave processor 120₁. In operation, the master processor 110 administers control over the slave processors 120₁-120_{K} by generating and transmitting instructions to a respective slave processor. A slave processor, which is an intended recipient of these instructions, is hereafter referred to as a destined slave processor. The instructions are transmitted, via the system interface 126₁, from the output buffer 114 of the master processor 110 to an input buffer 122₁ of the outermost slave processor 120₁.

To reach the destined slave processor, the instructions should be received and than re-transmitted, or forwarded, downstream by one or more intermediate upstream slave processors, i.e., the slave processors disposed between the master processor and the destined slave processor. Herein, the terms “to forward” and “to re-transmit” are used interchangeably.

More specifically, via the respective system interface, the instructions from an output buffer of an upstream slave processor are forwarded to an input buffer of the respective downstream slave processor (i.e., forwarded in a direction illustrated using arrow 103), which then similarly forwards the instructions further downstream until they reach the destined slave processor.

For example, when the destined slave processor is the slave processor 120₃, the slave processor 120₁, via the system interface 126₂, forwards the instructions downstream to the slave processor 120₂, which then re-transmits the instructions to the destined slave processor 120₃, where the instructions are executed.

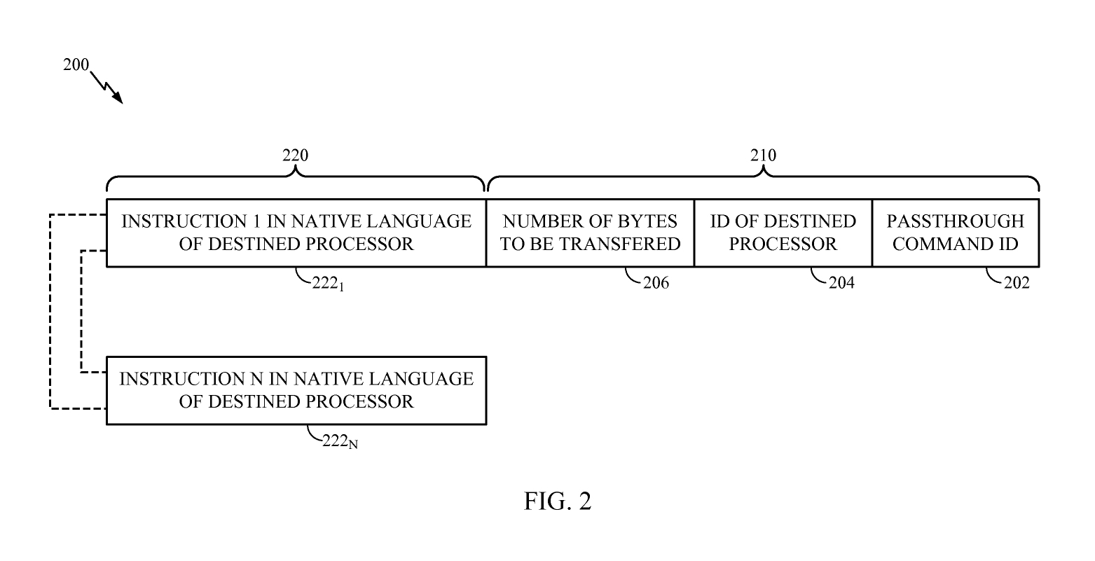

Referring to FIG. 2, to efficiently communicate instructions to a destined slave processor, the master processor 110 generates a pass-through command 200. In one embodiment, the pass-through command 200 instructs: (i) each non-destined slave processor to forward, without recoding, the pass-through command to a respective downstream slave processor (i.e., re-transmit the pass-through command in the direction of the arrow 103), and (ii) the destined slave processor to execute the instruction(s) contained in the pass-through command. In particular, the pass-through command 200 may instruct a non-destined slave processor 120 to copy the received pass-through command from its input buffer 122 to the output buffer 124 of that slave processor.

In one embodiment, the pass-through command 200 includes a header block 210 and a payload block 220. The header block 210 is coded using a computer language that is understood by all pipelined slave processors 120₁-120_{K} of the plurality 101. Herein, the term “computer language” is collectively used in reference to programming languages and formats for instructions and data used by the master and slave processors.

In one exemplary embodiment, the header block 210 includes data modules 202, 204, and 206. In alternate embodiments (not shown), contents of the data modules 202, 204, and 206 may form a single data module or contents of any two of these modules may be included in one data module.

A data module 202 contains information identifying the pass-through command 200 (i.e., an ID of the pass-through command) among other commands of the master processor 110. A data module 204 contains information identifying the destined slave processor (e.g., address of the destined slave processor), and a data module 206 contains information regarding a bit length (for example, in the units of bytes) of the payload block 220. In an alternate embodiment (not shown), in the header block 210, the data module 206 may precede the data module 204.

The payload block 220 is coded using a computer language that is understood by the destined slave processor and includes at least one data module 222 comprising an instruction generated by the master processor 110 for execution by the respective destined slave processor (data modules 222₁-222_{N} are shown, where N is an integer and N>1).

In further embodiments, the pass-through command 200 may instruct the destined slave processor to confirm the receipt or execution of the command by sending a pre-determined message upstream to the master processor 110 (i.e., in a direction illustrated using arrow 105). For example, to efficiently communicate such a message to the master processor 110, the pass-through command 200 may instruct the destined slave processor (i) to replace, in the data module 204 of the received pass-through command, information identifying the destined slave processor with information identifying the master processor 110, (ii) include the pre-determined message in the payload block 220, and (iii) forward the modified (i.e., reply) pass-through command to an adjacent upstream slave processor.

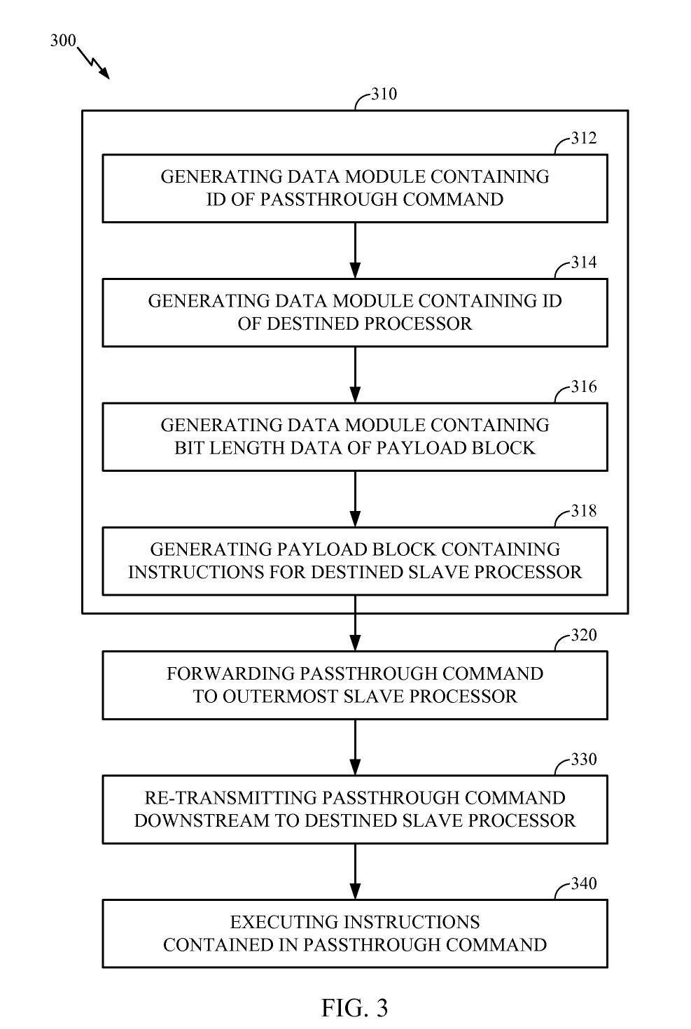

FIG. 3 depicts a flow diagram illustrating a method 300 for communicating instructions to pipelined slave processors 120 in the multi-processor system 100 of FIG. 1. In various embodiments, method steps of the method 300 are performed in the depicted order or at least two of these steps or portions thereof (e.g., sub-steps 312, 314, 316, and 318) may be performed contemporaneously, in parallel, or in a different order. Those skilled in the art will readily appreciate that an order of executing at least a portion of other discussed below processes or routines may also be modified. To best understand the invention, the reader should simultaneously refer to FIGS. 1-3.

At step 310, the master processor 110 generates the pass-through command 200. Illustratively, step 310 comprises sub-steps 312, 314, 316, and 318. In the depicted embodiment, during sub-steps 312, 314, and 316, the master processor 110 generates the header block 210 of the pass-through command 200 and, during sub-step 318, the master processor generates the payload block 220 of the pass-through command, respectively.

At sub-step 312, the master processor 110 generates the data module 202 of the header block 210. The data module 202 contains information identifying the pass-through command 200, and this information is coded using a computer language understood by each one of the slave processors 120₁-120_{K}. At sub-step 314, the master processor 110 generates the data module 204 of the header block 210. The data module 204 contains information identifying the destined slave processor (e.g., slave processor 120_{K}) and instructions for intermediate non-destined slave processors disposed between the master processor and the destined slave processor (i.e., slave processors 120₁-120_{K-1}).

In particular, the data module 204 contains a request for the non-destined slave processors to forward, without decoding, the pass-through command 200 downstream to the destined slave processor. In one embodiment, the non-destined slave processors are instructed to copy the pass-through command from an input buffer of a respective non-destined slave processor to the output buffer of the slave processor. Content of the data module 204 is coded using a computer language understood by each one of the slave processors 120₁-120_{K}.

At sub-step 316, the master processor 110 generates the data module 206 of the header block 210. The data module 206 contains information identifying a bit length of the payload block 220 of the pass-through command 200. Similar to the contents of the data modules 202 and 204, this information is coded using a computer language understood by each one of the slave processors 120₁-120_{K}. At sub-step 318, the master processor 110 generates the payload block 220 of the pass-through command 200. The payload block 220 contains at least one instruction 222 for the destined slave processor. Contents of the payload block 220 (i.e., instructions 222₁-222_{N}) are coded using a computer language understood by the destined slave processor (e.g., slave processor 120_{K}).

At step 320, the master processor 110 assembles the pass-through command 200 and transmits the command to the outmost slave processor (e.g., slave processor 120₁).

At step 330, when the outmost slave processor is the destined slave processor, that processor executes instructions contained in the payload block 220 of the command. Accordingly, when the outmost slave processor is not the destined slave processor, the outmost slave processor forwards (i.e., re-transmits) the pass-through command 200 downstream to the adjacent slave processor (i.e., slave processor 120₂), which, unless that slave processor is the destined slave processor, forwards the command to the next downstream slave processor (i.e., slave processor 120₃). Such cycles of re-transmitting the pass-through command 200 continue until the command reaches the destined slave processor. In one embodiment, during step 330, the received pass-through command 200 in copied, without recoding, from an input buffer of a recipient non-destined slave processor to an output buffer of that processor.

At step 340, the pass-through command 200 reaches the destined slave processor, which executes the instructions contained in the payload block 220 of the command. In one embodiment, such instructions may include a request from the master processor 110 to confirm the receipt or execution of the pass-through command. As discussed above in reference to FIG. 2, return communication from the destined slave processor may comprise a message included in the payload block 220 of a modified pass-through command addressed to the master processor 110. Such command is then sequentially re-submitted by the slave processors 120 disposed between the destined slave processor and the master processor 110 until the command reaches the master processor.

In exemplary embodiments, the method 300 may be implemented in hardware, software, firmware, or any combination thereof in a form of a computer program product comprising one or more computer-executable instructions. When implemented in software, the computer program product may be stored on or transmitted using a computer-readable medium, which includes computer storage medium and computer communication medium.

The term “computer storage medium” refers herein to any medium adapted for storing the instructions that cause the computer to execute the method. By way of example, and not limitation, the computer storage medium may comprise solid-sate memory devices, including electronic memory devices (e.g., RAM, ROM, EEPROM, and the like), optical memory devices (e.g., compact discs (CD), digital versatile discs (DVD), and the like), or magnetic memory devices (e.g., hard drives, flash drives, tape drives, and the like), or other memory devices adapted to store the computer program product, or a combination of such memory devices.

The term “computer communication medium” refers herein to any physical interface adapted to transmit the computer program product from one place to another using for example, a modulated carrier wave, an optical signal, a DC or AC current, and the like means. By way of example, and not limitation, the computer communication medium may comprise twisted wire pairs, printed or flat cables, coaxial cables, fiber-optic cables, digital subscriber lines (DSL), or other wired, wireless, or optical serial or parallel interfaces, or a combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An integrated circuit (IC) comprising: a master processor adapted to communicate with pipelined slave processors and adapted to: generate a pass-through command including a header block and a payload block, the header block being coded using a computer language understood by the pipelined slave processors; generate for a destined slave processor of the pipelined slave processors at least one instruction coded using a computer language understood by the destined slave processor; incorporate the at least one instruction in the payload block; and transmit the pass-through command to an outermost slave processor of the pipelined slave processors; wherein the pass-through command is forwarded, without recoding, from a non-destined slave processor of the pipelined slave processors to an adjacent downstream slave processor of the pipelined slave processors until the pass-through command reaches the destined slave processor.

2. The integrated circuit of claim 1, wherein the master processor is adapted to generate the pass-through command by: generating a data module containing information identifying the pass-through command and containing a request to forward the pass-through command, without de-coding, to the destined slave processor; and including the data module in the header block.

3. The integrated circuit of claim 1, wherein the master processor is adapted to generate the pass-through command by: generating a data module containing information identifying the destined slave processor; coding the data module in the computer language understood by the slave processors; and including the data module in the header block.

4. The integrated circuit of claim 1, wherein the master processor is adapted to generate the pass-through command by: generating a data module containing information identifying a bit length of the payload block; coding the data module using the computer language understood by the slave processors; and including the data module in the header block.

5. The integrated circuit of claim 1, wherein the master processor is adapted to transmit the pass-through command by forwarding the pass-through command to an outermost one of the pipelined slave processors.

6. The integrated circuit of claim 1, wherein the non-destined slave processor is adapted to copy the pass-through command from an input buffer of the non-destined slave processor to an output buffer of the non-destined slave processor.

7. The integrated circuit of claim 1, wherein the destined slave processor is adapted to acknowledge a receipt of the pass-through command.

8. The integrated circuit of claim 7, wherein the destined slave processor is adapted to: generate a pre-determined message using a computer language understood by the master processor; include the pre-determined message in the payload block of a reply pass-through command; address the pre-determined message to the master processor in the header block of the reply pass-through command; and forward the reply pass-through command to an upstream slave processor of the pipelined slave processors.

9. The integrated circuit of claim 1, wherein the master processor and pipelined slave processors are adapted for at least one of processing video data or rendering graphics.

10. The integrated circuit of claim 1, wherein the integrated circuit is a portion of a wireless communication apparatus selected from the group consisting of a cellular phone, a video game console, a personal digital assistant (PDA), a laptop computer, and an audio/video-enabled device.

11. An integrated circuit (IC) comprising: a plurality of pipelined slave processors for communication with a master processor adapted to: generate a pass-through command including a header block and a payload block, the header block coded using a computer language understood by the pipelined slave processors; generate for a destined slave processor of the pipelined slave processors at least one instruction coded using a computer language understood by the destined slave processor; incorporate the at least one instruction in the payload block; and transmit the pass-through command to an outermost slave processor of the pipelined slave processors; wherein a non-destined slave processor of the pipelined slave processors forwards, without recoding, the pass-through command to an adjacent downstream slave processor of the pipelined slave processors until the pass-through command reaches the destined slave processor.

12. The integrated circuit of claim 11, wherein the master processor is adapted to generate the pass-through command by: generating a data module containing information identifying the pass-through command and containing a request to forward the pass-through command, without de-coding, to the destined slave processor; and including the data module in the header block.

13. The integrated circuit of claim 11, wherein the master processor is adapted to generate the pass-through command by: generating a data module containing information identifying the destined slave processor; coding the data module in the computer language understood by the pipelined slave processors; and including the data module in the header block.

14. The integrated circuit of claim 11, wherein the master processor is adapted to generate the pass-through command by: generating a data module containing information identifying a bit length of the payload block; coding the data module using the computer language understood by the pipelined slave processors; and including the data module in the header block.

15. The integrated circuit of claim 11, wherein the master processor is adapted to transmit the pass-through command by forwarding the pass-through command to the outermost slave processor.

16. The integrated circuit of claim 11, wherein the master processor is further adapted to copy the pass-through command from an input buffer of the non-destined slave processor to an output buffer of the non-destined slave processor.

17. The integrated circuit of claim 11, wherein the master processor is further adapted to acknowledge a receipt of the pass-through command.

18. The integrated circuit of claim 17, wherein the master processor is further adapted to: generate a pre-determined message using a computer language understood by the master processor; include the pre-determined message in the payload block of a reply pass-through command; address the pre-determined message to the master processor in the header block of the reply pass-through command; and forward the reply pass-through command to an upstream slave processor of the pipelined slave processors.

19. The integrated circuit of claim 11, wherein the master processor and the pipelined slave processors are adapted for at least one of processing video data or rendering graphics.

20. The integrated circuit of claim 11, wherein the integrated circuit is a portion of a wireless communication apparatus selected from the group consisting of a cellular phone, a video game console, a personal digital assistant (PDA), a laptop computer, and an audio/video-enabled device.

21. A multi-processor system, comprising:
a plurality of pipelined slave processors including an outermost slave processor, a destined slave processor, and a non-destined slave processor; and
a master processor coupled to the outermost slave processor and adapted to: generate a pass-through command including a header block and a payload block, the header block being coded using a computer language understood by the pipelined slave processors, and the non-destined slave processor being adapted to forward, without recoding, the pass-through command to an adjacent downstream slave processor of the pipelined slave processors; generate for the destined slave processor at least one instruction coded using a computer language understood by the destined slave processor, the destined slave processor being adapted to execute the at least one instruction; incorporate the at least one instruction in the payload block; and transmit the pass-through command to the outermost slave processor.

22. The multi-processor system of claim 21, wherein the master processor is further adapted to: generate a data module containing information identifying the pass-through command and containing a request to forward the pass-through command, without de-coding, to the destined slave processor; and include the data module in the header block.

23. The multi-processor system of claim 21, wherein the master processor is further adapted to: generate a data module containing information identifying the destined slave processor; code the data module in the computer language understood by the pipelined slave processors; and include the data module in the header block.

24. The multi-processor system of claim 21, wherein the master processor is further adapted to: generate a data module containing information identifying a bit length of the payload block; code the data module using the computer language understood by the pipelined slave processors; and include the data module in the header block.

25. The multi-processor system of claim 21, wherein the master processor forwards the pass-through command to the outermost slave processor.

26. The multi-processor system of claim 21, wherein the non-destined slave processor copies the pass-through command from an input buffer of the non-destined slave processor to an output buffer of the non-destined slave processor.

27. The multi-processor system of claim 21, wherein the destined slave processor is further adapted to acknowledge a receipt of the pass-through command.

28. The multi-processor system of claim 27, wherein the destined slave processor is further adapted to: generate a pre-determined message using a computer language understood by the master processor; include the pre-determined message in the payload block of a reply pass-through command; address the pre-determined message to the master processor in the header block of the reply pass-through command; and forward the reply pass-through command to the upstream slave processor.

29. The multi-processor system of claim 21, wherein the multi-processor system performs at least one of processing video data or rendering graphics.

30. The multi-processor system of claim 21, wherein the multi-processor system is a portion of a wireless communication apparatus selected from the group consisting of a cellular phone, a video game console, a personal digital assistant (PDA), a laptop computer, and an audio/video-enabled device.

31. A multi-processor system having a master processor and pipelined slave processors, comprising:
first means for generating a pass-through command including a payload block and a header block coded using a computer language understood by the pipelined slave processors, generating for a destined slave processor of the pipelined slave processors at least one instruction coded using a computer language understood by the destined slave processor, including the at least one instruction in the payload block, and transmitting the pass-through command to one of the slave processors coupled to the master processor; and
second means for forwarding, without recoding, the pass-through command from a non-destined slave processor of the pipelined slave processors to an adjacent downstream slave processor of the pipelined slave processors, and for executing the at least one instruction at the destined slave processor.

32. The multi-processor system of claim 31, wherein the first means is a computer program executed by the master processor.

33. The multi-processor system of claim 31, wherein the second means is a computer program executed by the pipelined slave processors.

34. The multi-processor system of claim 31, wherein the first means includes means for generating a data module containing information identifying the pass-through command and containing a request to forward the pass-through command, without de-coding, to the destined slave processor, and for including the data module in the header block.

35. The multi-processor system of claim 31, wherein the first means includes means for generating a data module containing information identifying the destined slave processor, coding the data module in the computer language understood by the slave processors, and including the data module in the header block.

36. The multi-processor system of claim 31, wherein the first means includes means for generating a data module containing information identifying a bit length of the payload block, coding the data module using the computer language understood by the slave processors, and including the data module in the header block.

37. The multi-processor system of claim 31, wherein the second means includes means for acknowledging a receipt of the pass-through command.

38. The multi-processor system of claim 31, wherein the multi-processor system performs at least one of processing video data or rendering graphics.

39. The multi-processor system of claim 31, wherein the multi-processor system is a portion of a wireless communication apparatus selected from the group consisting of a cellular phone, a video game console, a personal digital assistant (PDA), a laptop computer, and an audio/video-enabled device.

40. A multi-processor system having a master processor and pipelined slave processors, comprising:
first means for generating a pass-through command using a code understood by the pipelined slave processors, the pass-through command including at least one instruction in a code understood by a destined slave processor of the pipelined slave processors; and
second means for forwarding, without recoding, the pass-through command to the destined slave processor.

41. The multi-processor system of claim 40, wherein the first means is a computer program executed by the master processor.

42. The multi-processor system of claim 40, wherein the second means is a computer program executed by the pipelined slave processors.

43. The multi-processor system of claim 40, wherein the pass-through command includes instructions that direct forwarding of the pass-through command to the destined slave processor.

44. The multi-processor system of claim 40, wherein the destined slave processor executes the at least one instruction and terminates forwarding of the pass-through command.

45. The multi-processor system of claim 40, wherein the destined slave processor generates a pre-determined reply message addressed to the first means using the code understood by the pipelined slave processors.

46. A computer program product including a computer readable medium having instructions for causing a multi-processor system including a master processor and pipelined slave processors to:
at the master processor: generate a pass-through command including a header block and a payload block, the header block being coded using a computer language understood by the pipelined slave processors; generate for a destined slave processor of the pipelined slave processors at least one instruction coded using a computer language understood by the destined slave processor; include the at least one instruction in the payload block; and transmit the pass-through command to a slave processor coupled to the master processor;
at a non-destined slave processor of the pipelined slave processors: forward, without recoding, the pass-through command to an adjacent downstream slave processor of the pipelined slave processors; and
at the destined slave processor: execute the at least one instruction.

47. The computer program product of claim 46, wherein at the master processor, the pass-through command is generated by: generating a data module containing information identifying the pass-through command and containing a request to forward the pass-through command, without de-coding, to the destined slave processor; and including the data module in the header block.

48. The computer program product of claim 46, wherein at the master processor, the pass-through command is generated by: generating a data module containing information identifying the destined slave processor; coding the data module in the computer language understood by the pipelined slave processors; and including the data module in the header block.

49. The computer program product of claim 46, wherein at the master processor, the pass-through command is generated by: generating a data module containing information identifying a bit length of the payload block; coding the data module using the computer language understood by the pipelined slave processors; and including the data module in the header block.

50. The computer program product of claim 46, wherein at the master processor, the pass-through command is transmitted by: forwarding the pass-through command to an outermost slave processor of the pipelined slave processors.

51. The computer program product of claim 46, wherein the computer readable medium further has instructions for causing the non-destined slave processor to copy the pass-through command from an input buffer of the non-destined slave processor to an output buffer of the non-destined slave processor.

52. The computer program product of claim 46, wherein the computer readable medium further has instructions for causing the destined slave processor to acknowledge a receipt of the pass-through command.

53. The computer program product of claim 52, wherein the computer readable medium further has instructions for causing the destined slave processor to: generate a pre-determined message using a computer language understood by the master processor; include the pre-determined message in the payload block of a reply pass-through command; address the pre-determined message to the master processor in the header block of the reply pass-through command; and forward the reply pass-through command to an upstream slave processor of the pipelined slave processors.

54. The computer program product of claim 46, wherein the master processor and pipelined slave processors are adapted for at least one of processing video data or rendering graphics in a wireless communication apparatus selected from the group consisting of a cellular phone, a video game console, a personal digital assistant (PDA), a laptop computer, and an audio/video-enabled device.

55. A computer program product including a computer readable medium having instructions for causing a multi-processor system including a master processor and pipelined slave processors to:
at the master processor: generate a pass-through command using a code understood by the pipelined slave processors, the pass-through command including at least one instruction in a code understood by a destined slave processor of the pipelined slave processors; and
at a non-destined slave processor of the pipelined slave processors: forward the pass-through command, without recoding, to an adjacent downstream slave processor of the pipelined slave processors until the pass-through command reaches the destined slave processor.

56. A method for communicating instructions to a slave processor in a multi-processor system having a master processor and pipelined slave processors, the method comprising:
at the master processor: generating a pass-through command including a header block and a payload block, the header block being coded using a computer language understood by the pipelined slave processors; generating for a destined slave processor of the pipelined slave processors at least one instruction coded using a computer language understood by the destined slave processor; including the at least one instruction in the payload block; and transmitting the pass-through command to a slave processor of the pipelined slave processors adapted for coupling to the master processor;
at a non-destined slave processor: forwarding, without recoding, the pass-through command to an adjacent downstream slave processor of the pipelined slave processors; and
at the destined slave processor: executing the at least one instruction.

57. The method of claim 56, wherein the step of generating the pass-through command comprises: generating a data module containing information identifying the pass-through command and containing a request to forward the pass-through command, without de-coding, to the destined slave processor; and including the data module in the header block.

58. The method of claim 56, wherein the step of generating the pass-through command comprises: generating a data module containing information identifying the destined slave processor; coding the data module in the computer language understood by the pipelined slave processors; and including the data module in the header block.

59. The method of claim 56, wherein the step of generating the pass-through command comprises: generating a data module containing information identifying a bit length of the payload block; coding the data module using the computer language understood by the pipelined slave processors; and including the data module in the header block.

60. The method of claim 56, wherein the step of transmitting the pass-through command further comprises: forwarding the pass-through command to an outermost slave processor of the pipelined slave processors.

61. The method of claim 56, wherein at the non-destined slave processor, further comprising: copying the pass-through command from an input buffer of the non-destined slave processor to an output buffer of the non-destined slave processor.

62. The method of claim 56, wherein at the destined slave processor, further comprising: acknowledging a receipt of the pass-through command.

63. The method of claim 62, wherein at the destined slave processor, further comprising: generating a pre-determined message using a computer language understood by the master processor; including the pre-determined message in the payload block of a reply pass-through command; addressing the pre-determined message to the master processor in the header block of the reply pass-through command; and forwarding the reply pass-through command to an upstream slave processor of the pipelined slave processors.

64. The method of claim 56, wherein the master processor and slave processors are adapted for at least one of processing video data or rendering graphics.

65. A wireless apparatus comprising: a master processor and slave processors controlled by the master processor for executing the method of claim 56, wherein the wireless apparatus is selected from the group consisting of a cellular phone, a video game console, a personal digital assistant (PDA), a laptop computer, and an audio/video-enabled device.

66. A method for communicating instructions to a slave processor in a multi-processor system having a master processor and pipelined slave processors, the method comprising:
at the master processor: generating a pass-through command using a code understood by the pipelined slave processors, the pass-through command including at least one instruction in a code understood by a destined slave processor of the pipelined slave processors; and
at a slave processor of the pipelined slave processors: forwarding the pass-through command, without recoding, to an adjacent downstream slave processor of the pipelined slave processors until the pass-through command reaches the destined slave processor.

67. The method of claim 66, wherein at the destined slave processor, further comprising: executing the at least one instruction: and terminating forwarding of the pass-through command.

68. The method of claim 66, further comprising:
at the destined slave processor: generating a pre-determined reply message addressed to the master processor using the code understood by the pipelined slave processors; and
at the slave processor: forwarding the reply message, without recoding, to an adjacent upstream slave processor of the pipelined slave processors until the reply message reaches the master processor.

69. A wireless apparatus comprising: a master processor and slave processors controlled by the master processor for executing the method of claim 66; wherein the wireless apparatus is selected from the group consisting of a cellular phone, a video game console, a personal digital assistant (PDA), a laptop computer, and an audio/video-enabled device.
